(19) United States
(12) Patent Application Publication
(10) Pub. No.: US 2015/0033857 A1
(43) Pub. Date: Feb. 5, 2015

(54) MULTICHANNEL SENSOR UNIT AND ASSOCIATED OPERATING METHOD

(71) Applicant: ROBERT BOSCH GMBH, Stuttgart (DE)

(72) Inventors: Sascha Kopplin, Bietigheim-Bissingen (DE); Hoang Trinh, Gerlingen (DE)

(21) Appl. No.: 14/384,769

(22) PCT Filed: Mar. 4, 2013
(86) PCT No.: PCT/EP2013/054251

§ 371 Date: Sep. 12, 2014

(30) Foreign Application Priority Data
Mar. 14, 2012 (DE) 10 2012 203 968.6

(51) Int. Cl. G01P 15/00

(52) U.S. Cl. CPC G01P 15/00
USPC 73/511

(57) ABSTRACT

A multichannel sensor unit includes: a multichannel sensor detecting at least one physical variable and outputting sensor data representing the detected physical variable; a main memory storing the sensor data of at least two sensor channels; and at least one additional memory. Instantaneous sensor data are stored in response to a trigger signal in the main memory. The sensor unit outputs first sensor data of a first sensor channel, which are stored in the main memory, in response to a first read command, and stores the additional sensor data in the at least one additional memory in response to the first read command. The sensor unit outputs the sensor data stored in the at least one additional memory in response to a second read command, such that the sensor unit outputs the sensor data from the main memory and the additional memory asynchronously.

### BACKGROUND OF THE INVENTION

1. Field of the Invention

The present invention relates to a multichannel sensor unit for a vehicle, and a method for operating a multichannel sensor unit in a vehicle.

2. Description of the Related Art

Two-channel sensor units for detecting accelerations, which send sensor data to an associated airbag control unit cyclically every 500 μs, are known for crash sensing in vehicles. The data communication between the two-channel sensor unit and the airbag control unit is generally managed according to an SPI protocol. This means that the airbag control unit reads out the sensor data from the two channels of the sensor unit asynchronously at a time interval of approx. 2 μs within a 500 μs reading cycle. Such a two-channel sensor unit includes at least one two-channel sensor for detecting accelerations and for outputting a sensor signal for each sensor channel. Furthermore, a signal processing unit is also provided for each sensor channel for processing a corresponding sensor signal and for outputting corresponding sensor data to an interface unit. The interface unit exchanges data with the control unit via the SPI protocol. In addition, a main register is assigned to each sensor channel. The main registers store the detected acceleration values continuously as the instantaneous sensor data. In response to read commands, the interface unit outputs the sensor data stored in the corresponding main register asynchronously. This means that, on receipt of a first read command, for example, the interface unit outputs the instantaneous first sensor data stored in the first main register of the first sensor channel and outputs the instantaneous second sensor data stored in the second main register of the second sensor channel on receipt of a second read command. There is therefore the risk that the contents of the second sensor data in the second main register may have changed and the first and second sensor data no longer represent the acceleration values detected at the same time but instead represent acceleration values of the two sensor channels detected at different points in time. With the introduction of the 32-bit SPI protocol, the time interval between readout of the first and second sensor data and the error between the first and second sensor channels increases because of the asynchronous scanning.

### BRIEF SUMMARY OF THE INVENTION

The multichannel sensor unit according to the present invention has the advantage over the related art that the sensor data of multiple channels output time-synchronous data despite the time-offset asynchronous readout operations. This means that the values of physical variables detected at the same time may be output as corresponding sensor data at time-offset asynchronous readout points in time. This advantageously permits reliable interference suppression (common mode rejection), the interferences being caused by EMC or operational fluctuations on the power supply lines, for example. Specific embodiments of the present invention advantageously permit an accurate assessment of the in-phase deflection in the event of electrical interferences (PSRR and EMC) as well as a safety-critical assessment of 45° applications. In addition, specific embodiments of the present invention may be implemented in the ASIC (application-specific integrated circuit) with minimal effort.

Specific embodiments of the present invention make available a multichannel sensor unit including at least one multichannel sensor for detecting at least one physical variable and for outputting of sensor data which represent the detected physical variable. The sensor unit here includes at least one main memory means, which stores the sensor data from at least two sensor channels, the sensor unit outputting the sensor data in response to corresponding read commands. According to the present invention, the sensor unit has at least one additional memory means, and the sensor unit stores the instantaneous sensor data in response to a trigger signal simultaneously in the at least one main memory means. The sensor unit outputs first sensor data of a first sensor channel in response to a first read command, the sensor data being stored in the at least one main memory means. Furthermore, the sensor unit stores additional sensor data in response to the first read command in the at least one additional memory means, the sensor unit outputting the sensor data stored in the at least one additional memory means in response to at least one additional corresponding read command.

In addition, a method for operating a multichannel sensor unit, including at least one multichannel sensor, is provided. At least one physical variable is detected via the at least one multichannel sensor and output as sensor data which represent the detected physical variable. The sensor data of at least two sensor channels are stored in at least one main memory means and are output asynchronously in response to corresponding read commands. According to the present invention, the instantaneous sensor data are stored simultaneously in the at least one main memory means in response to a trigger signal. In response to a first read command, first sensor data of a first sensor channel are output, which are stored in the at least one main memory means. Furthermore, in response to the first read command, additional sensor data, which are stored in the at least one main memory means, are stored in at least one additional memory means, the sensor data stored in the at least one additional memory means being output in response to at least one additional corresponding read command.

A sensor unit in the present case is understood to be a modular unit, which includes at least one sensor element, this sensor element directly or indirectly detecting a physical variable or a change in a physical variable and preferably converting it into an electrical sensor signal. This may be accomplished by transmission and/or reception of sound waves and/or electromagnetic waves, for example, and/or via a magnetic field or the change in a magnetic field and/or reception of satellite signals, for example, a GPS signal. The sensor unit may have at least one interface, which may be implemented in hardware and/or software. In a hardware design, the interfaces may be part of a so-called system ASIC, for example, which includes various functions of the sensor unit. However, it is also possible for the interfaces to be separate integrated circuits or to at least include discrete components. In a software design, the interfaces may be software modules, which are present in a microcontroller, for example, in addition to other software modules. Also advantageous is a computer program product having program code which is stored on a machine-readable carrier such as a semiconductor memory, a hard drive memory or an optical memory and is used to carry out the analysis when the program is executed by an evaluation and control unit in the sensor unit.

Optical sensor elements, which have a photographic plate and/or a fluorescent surface and/or a semiconductor, which detect the incidence or the intensity, the wavelength, the frequency, the angle, etc. of the received wave, for example, such as infrared sensor elements, for example, are also possible. Likewise, it is also conceivable to have an acoustic sensor element, such as an ultrasonic sensor element and/or a high-frequency sensor element and/or a radar sensor element and/or a sensor element, which responds to a magnetic field, such as a Hall sensor element, for example, and/or a magnetoresistive sensor element and/or an inductive sensor element, which records the change in a magnetic field based on the resulting voltage due to magnetic induction, for example. The sensor signals may be ascertained statically and/or dynamically. In addition, the sensor signals may be ascertained continuously or only once.

A control unit in the present case may be understood to be an electrical device such as an airbag control unit, for example, which receives sensor signals detected by the sensor unit and processes and analyzes them and controls the sensor unit by transmitting control signals.

It is advantageous in particular that the at least one multichannel sensor has a sensor element for each sensor channel for detecting the at least one physical variable. The sensor elements may detect, for example, different physical variables or the same physical variables in the same detection direction or in multiple detection directions.

In an advantageous embodiment of the sensor unit according to the present invention, the sensor has a two-channel design, a first sensor element detecting a first acceleration in a first spatial direction, and a second sensor element detecting a second acceleration in a second spatial direction. The first sensor element may detect the first acceleration in the vehicle's transverse direction, for example, and the second sensor element may detect the second acceleration in a vehicle's longitudinal direction. The two sensor channels may advantageously be analyzed to detect different types of crashes. Furthermore, the first sensor channel may be analyzed for crash detection, for example, and the second sensor channel may be analyzed for a plausibility check on the first sensor channel.

In another advantageous embodiment of the sensor unit according to the present invention, an interface unit is provided, which manages a data communication with an external control unit via an SPI bus protocol.

In an advantageous embodiment of the method according to the present invention, different physical variables or the same physical variables are detected in the same detection direction or in multiple detection directions via the at least one multichannel sensor. Thus, a first acceleration in the vehicle's transverse direction may be detected, and a second acceleration in a vehicle's longitudinal direction may be detected, for example. The two sensor channels may then be analyzed advantageously to detect different types of crashes. Furthermore, the first sensor channel may be analyzed for crash detection, for example, and the second sensor channel may be analyzed for a plausibility check on the first sensor channel.

In another advantageous embodiment of the method according to the present invention, a third acceleration is detected at a first angle of (45°) to the vehicle's longitudinal direction, and a second acceleration is detected at a second angle of (−) 45° to the vehicle's longitudinal direction. In such a 45° application, the acceleration values in the vehicle's longitudinal direction and in the vehicle's transverse direction are ascertained geometrically from the sensor data of the two sensor channels, the instantaneous acceleration value in the vehicle's longitudinal direction being ascertained by geometric subtraction of the sensor data of the two sensor channels, and the instantaneous acceleration value in the vehicle's transverse direction being ascertained by geometric addition of the sensor data of the two sensor channels. So-called “common mode rejection” may be achieved by the subtraction for the instantaneous acceleration value in the vehicle's longitudinal direction.

Exemplary embodiments of the present invention are illustrated in the drawings and explained in greater detail in the following description. In the drawings, the same reference numerals denote the same components or elements, which carry out the same or similar functions.

### BRIEF DESCRIPTION OF THE DRAWINGS

FIG. 1 shows a schematic block diagram of a sensor array in an exemplary embodiment of a multichannel sensor unit according to the present invention and an analysis and control unit.

FIG. 2 shows a schematic diagram of a 45° application of a multichannel sensor unit according to the present invention for the sensor array from FIG. 1.

FIG. 3 shows a more detailed diagram of a signal processing unit for the multichannel sensor unit from FIG. 1 or FIG. 2.

FIG. 4 shows a schematic flow chart of an exemplary embodiment of a method according to the present invention for operating a multichannel sensor unit for a vehicle.

### DETAILED DESCRIPTION OF THE INVENTION

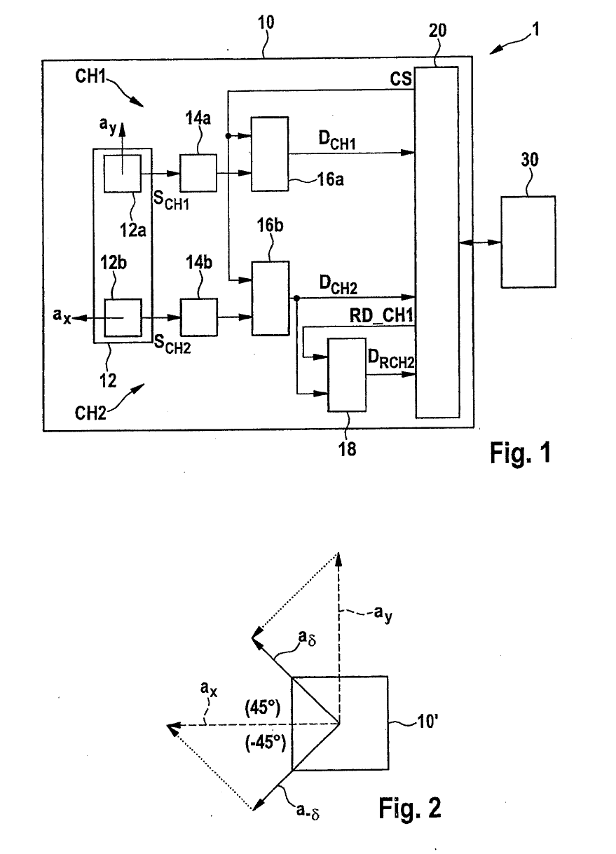

As is apparent from FIG. 1, the exemplary embodiment of a multichannel sensor unit 10 according to the present invention for a vehicle, shown here, includes a multichannel sensor 12 for detecting a physical variable aₓ, a_{y} and for outputting of a sensor signal S_{CH1}, S_{CH2} for the two sensor channels CH1, CH2, and an interface unit 20, via which sensor unit 10 is connected to a control unit 30. As is also apparent from FIG. 1, a signal processing unit 14a, 14b is provided for the two sensor channels CH1, CH2 for processing a corresponding sensor signal S_{CH1}, S_{CH2} and for outputting corresponding sensor data D_{CH1}, D_{CH2} which represent detected physical variables aₓ, a_{y}, to interface unit 20. Sensor unit 10 has at least one main memory means 16a, which stores the sensor data D_{CH1}, D_{CH2} of at least two sensor channels CH1, CH2. In the exemplary embodiment presented here, one main memory means 16a, 16b, which is designed as a register, for example, and stores the respective instantaneous sensor data D_{CH1}, D_{CH2}, is assigned to the two sensor channels CH1, CH2. Sensor unit 10 outputs stored sensor data D_{CH1}, D_{CH2} asynchronously to control unit 30 via interface unit 20 in response to the corresponding read commands.

According to the present invention, sensor unit 10 has at least one additional memory means 18 and sensor unit 10 stores the instantaneous sensor data D_{CH1,} D_{CH2} in response to a trigger signal CS simultaneously in the at least one memory means 16a, 16b. Sensor unit 10 outputs first sensor data D_{CH1} of a first sensor channel CH1, which are stored in the at least one main memory means 16a in response to a first read command RD_CH1. Furthermore, sensor unit 10 stores additional sensor data D_{CH2} in response to the first read command RD_CH1 in the at least one additional memory means 18. In response to at least one additional corresponding read command, sensor unit 10 outputs sensor data D_{RCH2} stored in the at least one additional memory means 18. The at least one additional memory means is preferably also designed as a register.

For communication with external control unit 30, interface unit 20 of sensor unit 10 utilizes an SPI bus protocol, which means that sensor data D_{CH1}, D_{CH2} is transferred into main memory means 16a, 16b at the trailing edge of a chip select signal (CS). The first sensor channel is then read via SPI command RD_SensorData_CH0, which corresponds to read command RD_CH1 shown in FIG. 1. With SPI command RD_SensorData_CH0 (RD_CH1 in FIG. 1), data of first main memory means 16a are transferred into additional memory means 18. The contents of additional memory means 18 are thus synchronous with the read-out first sensor data D_{CH1} of first sensor channel CH1. Sensor data D_{RCH2} stored in additional memory means 18 may be read out via SPI command RD_CapturedData_CH1. Furthermore, second sensor data D_{CH2} stored in second main memory means 16b may also read out via an SPI command RD_SensorData_CH1 and analyzed.

In the first exemplary embodiment presented here, sensor unit 10 has a two-channel design, the two sensor channels CH1, CH2 detecting an acceleration aₓ, a_{y} as a physical variable in a predefined detection direction x, y. Two-channel sensor 12 includes a first sensor element 12a for detecting a first acceleration a_{y} in a first spatial direction y, which corresponds to a vehicle's transverse direction, and a second sensor element 12b for detecting a second acceleration aₓ in a second spatial direction x, which corresponds to a vehicle's longitudinal direction. In alternative specific embodiments of the present invention, sensor elements 12a, 12b may also detect different physical variables in the same detection direction or in a plurality of detection directions or they may detect the same physical variable in the same detection direction.

FIG. 2 shows a 45° application of a multichannel sensor unit 10′ according to the present invention. As is apparent from FIG. 2, sensor unit 10′ also has a two-channel design in the 45° application, and the two sensor channels CH1, CH2 each detect an acceleration a_{δ}, a_{-δ} as a physical variable in a predefined detection direction δ, −δ. In contrast with the first exemplary embodiment, a first sensor element 12a detects a first acceleration a_{δ} in a first spatial direction δ, which forms a 45° angle to the vehicle's longitudinal direction, and a second sensor element 12b detects a second acceleration a_{-δ} in a second spatial direction−δ, which forms a −45° angle to the vehicle's longitudinal direction. This means that acceleration aₓ in the vehicle's longitudinal direction is calculated by geometric (vectorial) subtraction of the two detected accelerations a_{δ}, a_{-δ}, and acceleration a_{y} in the vehicle's transverse direction is calculated by geometric (vectorial) addition of the two detected accelerations a_{δ}, a_{-δ}. This subtraction makes it possible advantageously to achieve a so-called “common mode rejection” for the instantaneous acceleration value aₓ in vehicle longitudinal direction x.

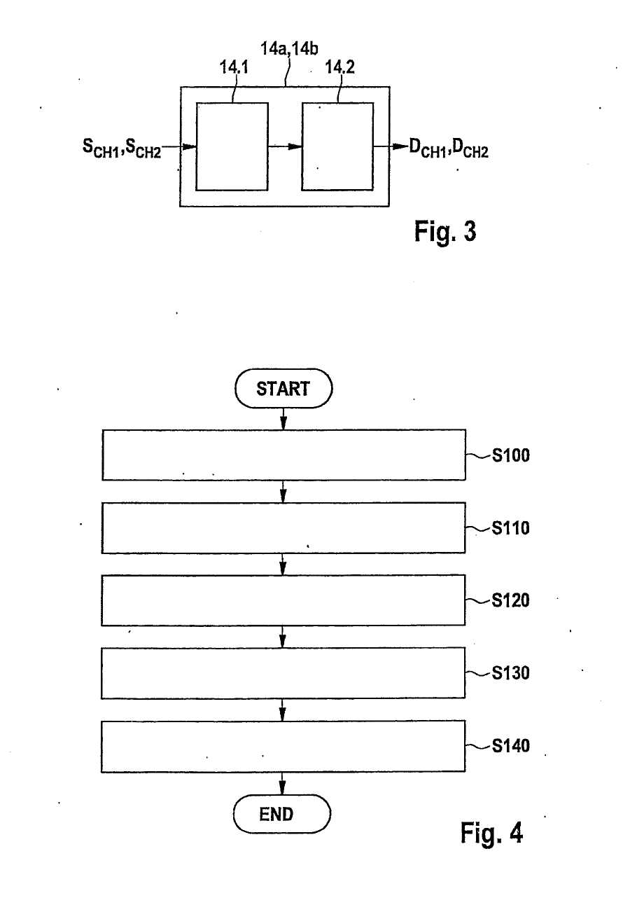

As is apparent from FIG. 3, signal processing unit 14a, 14b includes one digital filter unit (FIR) 14.1 for the two sensor channels CH1, CH2 and one offset unit 14.2, which removes an existing offset from sensor signal S_{CH1}, S_{CH2} and outputs sensor data D_{CH1}, D_{CH2}.

FIG. 4 shows an exemplary embodiment of a method according to the present invention for operating a multichannel sensor unit 10, 10′ for a vehicle, including at least one multichannel sensor 12 and one interface unit 20.

As is apparent from FIG. 4, in a step S100, a physical variable aₓ, a_{y}, a_{-δ}, a_{δ} is detected simultaneously for at least two sensor channels CH1, CH2 via the at least one multichannel sensor 12, and this physical variable is output as corresponding sensor signal S_{CH1}, S_{CH2}. In a step S110, corresponding sensor signals S_{CH1}, S_{CH2} are processed in the two sensor channels CH1, CH2 and converted into corresponding sensor data D_{CH1}, D_{CH2}. In a step S120, instantaneous sensor data D_{CH1}, D_{CH2} are stored in response to a trigger signal CS simultaneously in one main memory means 16a, 16b assigned to corresponding sensor channel CH1, CH2. In step S130, first sensor data D_{CH1} of first sensor channel CH1 stored in first main memory means 16a are output via interface unit 20 in response to a first read command RD_CH1. At the same time, sensor data D_{CH2} stored in the other main memory means 16b of the other sensor channels CH2 are stored in at least one additional memory means 18 in response to first read command RD_CH1. In a step S140, sensor data D_{RCH2} stored in the at least one additional memory means 18 are output via interface unit 20 in response to at least one additional corresponding read command.

Specific embodiments of the present invention make available a multichannel sensor unit, which outputs sensor data of multiple channels, despite the time-offset asynchronous readout operations, using time-synchronous data. This means that the values of physical variables detected at the same time may be output as corresponding sensor data at time-offset asynchronous readout points in time.

1-10. (canceled)

11. A multichannel sensor unit, comprising:
at least one multichannel sensor detecting at least one physical variable and outputting sensor data which represent the detected physical variable;
at least one main memory which stores the sensor data of at least two sensor channels; and
at least one additional memory;
wherein the sensor unit (i) stores the instantaneous sensor data in the at least one main memory simultaneously in response to a trigger signal, (ii) outputs first sensor data of a first sensor channel, which are stored in the at least one main memory, in response to a first read command, (iii) stores second sensor data in the at least one additional memory in response to the first read command, and (iv) outputs the sensor data stored in the at least one additional memory in response to a second read command, whereby the first sensor data and the second sensor data are output asynchronously in response to the first and second read commands.

12. The sensor unit as recited in claim 11, wherein the at least one multichannel sensor has a respective sensor element for each sensor channel for detecting the at least one physical variable.

13. The sensor unit as recited in claim 12, wherein the sensor elements detect different physical variables in multiple detection directions.

14. The sensor unit as recited in claim 13, wherein the sensor has a two-channel design, a first sensor element detecting a first acceleration in a first spatial direction, and a second sensor element detecting a second acceleration in a second spatial direction.

15. The sensor unit as recited in claim 14, wherein the sensor unit is located in a vehicle, and wherein the first sensor element detects the first acceleration in the vehicle's transverse direction, and the second sensor element detects the second acceleration in the vehicle's longitudinal direction.

16. The sensor unit as recited in claim 15, further comprising:
an interface unit which manages a data communication with an external control unit via an SPI bus protocol.

17. A method for operating a multichannel sensor unit including at least one multichannel sensor, comprising:
detecting, by the at least one multichannel sensor, at least one physical variable, and outputting sensor data which represent the detected physical variable;
storing, using at least one main memory, instantaneous sensor data of at least two sensor channels simultaneously in response to a trigger signal;
outputting, from the at least one main memory, first sensor data of a first sensor channel in response to a first read command;
storing second sensor data in at least one additional memory in response to the first read command; and
outputting the sensor data stored in the at least one additional memory in response to a second read command; whereby the first sensor data and the second sensor data are output asynchronously in response to the first and second read commands.

18. The method as recited in claim 17, wherein the at least one multichannel sensor detects different physical variables in multiple detection directions.

19. The method as recited in claim 18, wherein the sensor unit is located in a vehicle, and wherein the at least one multichannel sensor detects (i) a first acceleration in the vehicle's transverse direction, and (ii) a second acceleration in the vehicle's longitudinal direction.

20. The method as recited in claim 19, wherein the at least one multichannel sensor detects a third acceleration at a first angle of 45° to the vehicle's longitudinal direction, and a fourth acceleration at a second angle of −45° to the vehicle's longitudinal direction.
